(19) United States
(12) Patent Application Publication
(10) Pub. No.: US 2022/0207375 A1
(43) Pub. Date: Jun. 30, 2022

(54) CONVOLUTIONAL NEURAL NETWORK TUNING SYSTEMS AND METHODS

(71) Applicant: Intel Corporation, Santa Clara, CA (US)

(72) Inventors: Seok-Yong BYUN, Seoul (KR); Byungseok ROH, Seoul (KR); Minje PARK, Seongnam (KR); Byoungwon CHOE, Seoul (KR)

(21) Appl. No.: 17/572,487

(22) Filed: Jan. 10, 2022

Related U.S. Application Data
(63) Continuation of application No. 15/706,930, filed on Sep. 18, 2017.

(51) Int. Cl. G06N 3/08; G06N 3/04

(52) U.S. Cl. CPC G06N 3/082; G06N 3/04; G05B 13/027; G06N 3/084; G06N 3/0454

(57) ABSTRACT

Systems and methods are provided that tune a convolutional neural network (CNN) to increase both its accuracy and computational efficiency. In some examples, a computing device storing the CNN includes a CNN tuner that is a hardware and/or software component that is configured to execute a tuning process on the CNN. When executing according to this configuration, the CNN tuner iteratively processes the CNN layer by layer to compress and prune selected layers. In so doing, the CNN tuner identifies and removes links and neurons that are superfluous or detrimental to the accuracy of the CNN.

### CROSS-REFERENCE TO RELATED APPLICATIONS

This application is a continuation of U.S. patent application Ser. No. 15/706,930, filed Sep. 18, 2017. The entire specification of which is hereby incorporated by reference in its entirety.

### BACKGROUND

Convolutional neural networks (CNNs) are broadly applicable to content detection and classification. CNNs are currently used, for example, to accurately detect and classify objects depicted in images and words recited in recordings. However, some CNNs require substantial computing resources to infer a classification in a timely manner. For this reason, techniques to increase the computational efficiency of CNNs have emerged. These techniques include specialized training and post processing techniques. Training techniques designed to increase computation efficiency include use of high quality, domain specific, training data coupled with carefully designed loss functions for backpropagation training. Post processing techniques designed to increase computational efficiency include removing inconsequential elements from already trained CNNs. While these techniques provide benefits, in at least some instances, these techniques sacrifice accuracy for computational efficiency.

### BRIEF DESCRIPTION OF THE DRAWINGS

FIG. 1 is a block diagram illustrating a computing device including a CNN tuner configured in accordance with an example of the present disclosure.

FIG. 2 is a block diagram illustrating the CNN shown in FIG. 1 in greater detail.

FIG. 3 is a flow chart illustrating a CNN tuning process in accordance with an example of the present disclosure.

FIG. 4 is a flow chart illustrating a compression process in accordance with an example of the present disclosure.

FIG. 5 is a block diagram illustrating a portion of a CNN before and after being tuned in accordance with an example of the present disclosure.

FIG. 6 is a set of matrices operated on by a CNN tuner in accordance with an example of the present disclosure.

FIG. 7 illustrates computing devices configured in accordance with an example of the present disclosure.

FIG. 8 illustrates a mobile computing system configured in accordance with an example of the present disclosure.

### DETAILED DESCRIPTION

The systems and methods disclosed herein tune a CNN to increase both its accuracy and computational efficiency. In some examples, a computing device storing the CNN includes a CNN tuner that is a hardware and/or software component that is configured to execute a tuning process on the CNN. When executing according to this configuration, the CNN tuner iteratively processes the CNN layer by layer to compress and prune selected layers. In so doing, the CNN tuner identifies and removes links and neurons that are superfluous or detrimental to the accuracy of the CNN.

In some examples, the CNN tuner is configured to compress a layer of the CNN by executing a truncated singular value decomposition (SVD) process. This truncated SVD process reduces the rank of a matrix that stores weight values associated with links in the layer. In some examples, the truncated SVD process decomposes each of the weight matrix into 3 distinct but related matrices uΣv*. The Σ matrix stores diagonal values that indicate and the relative importance of eigenvectors stored in the u and v* matrices to the truncated SVD representation of the weight matrix. For this reason, some examples of the CNN tuner truncate the Σ and v* matrices and further multiply the truncated Σ matrix with the truncated v* matrix to generate a compressed version of the weight matrix. In some examples, the CNN tuner is also configured to prune the compressed version of the weight matrix to further increase the computational efficiency of the layer and the CNN.

In some examples, the CNN tuner is configured to determine accuracy metrics for the respective truncated and pruned (i.e., tuned) layers and for the CNN overall after each iteration of layer truncating and pruning (i.e., tuning). When executing according to these configurations, the CNN tuner may calculate, for example, mean average precision (mAP) for both a tuned layer and for the overall CNN. In some examples, the CNN tuner is configured to repeatedly truncate and prune (i.e., tune) a layer until the layer meets an accuracy threshold. In some examples, the CNN tuner is also configured to tune multiple layers until the CNN meets an overall accuracy threshold.

Still other aspects, examples and advantages are discussed in detail below. Moreover, it is to be understood that both the foregoing information and the following detailed description are merely illustrative examples of various aspects and examples, and are intended to provide an overview or framework for understanding the nature and character of the claimed aspects and examples. References to “an example,” “other examples,” “some examples,” “some examples,” “an alternate example,” “various examples,” “one example,” “at least one example,” “another example,” “this and other examples” or the like are not necessarily mutually exclusive and are intended to indicate that a particular feature, structure, or characteristic described in connection with the example may be included in at least one example. The appearances of such terms herein are not necessarily all referring to the same example. Any example disclosed herein may be combined with any other example.

Also, the phraseology and terminology used herein is for the purpose of description and should not be regarded as limiting. Any references to examples, components, elements, or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

### General Overview

As explained above, conventional techniques for increasing the computational efficiency of CNNs can compress a CNN and thereby decrease the computing resources required to operate it. However, these conventional techniques also tend to decrease, or at best simply maintain, CNN accuracy.

Thus, and in accordance with at least some examples disclosed herein, a computing device is configured to implement a CNN tuner that executes simple but robust CNN tuning processes that compress a CNN while increasing its accuracy. These CNN tuning processes remove unnecessary ranks in CNN tensors (e.g., weight matrices) and also prune remaining near zero weights to additionally regularize the CNN tensors. The CNN tuner and CNN tuning processes are effective for CNNs containing convolutional and/or fully-connected layers, which are common in many object classification and detection applications. In some examples, the CNN tuner and CNN tuning processes increase inference/generalization capability (i.e., detection accuracy) by regularizing a CNN when pruning its layers. The demonstrated effectiveness of the CNN tuner and CNN tuning processes disclosed herein has enabled tuned CNNs to achieve state-of-the-art accuracy with an order of magnitude less computation than conventional, untuned CNNs.

### System Architecture

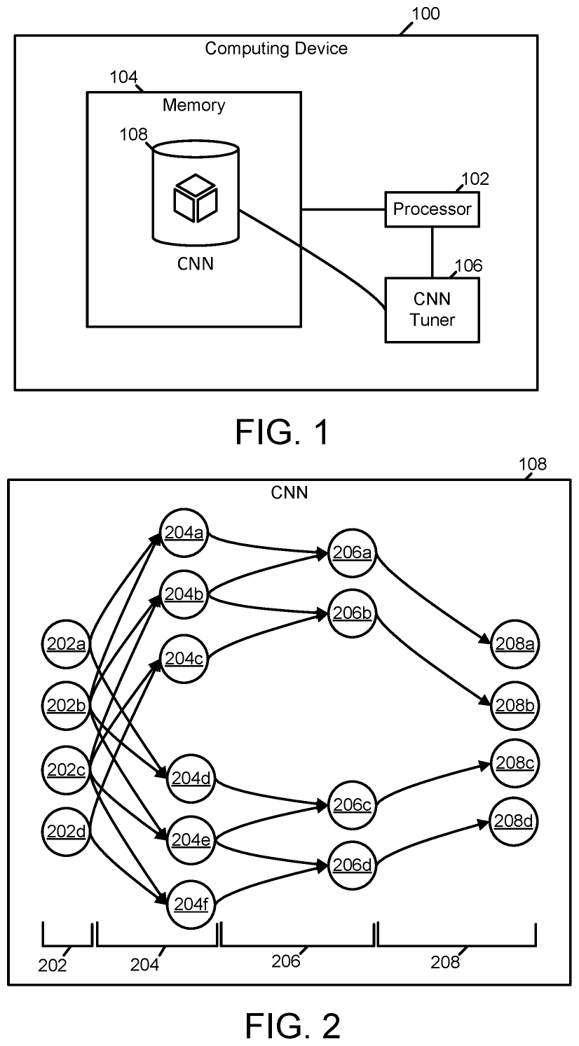

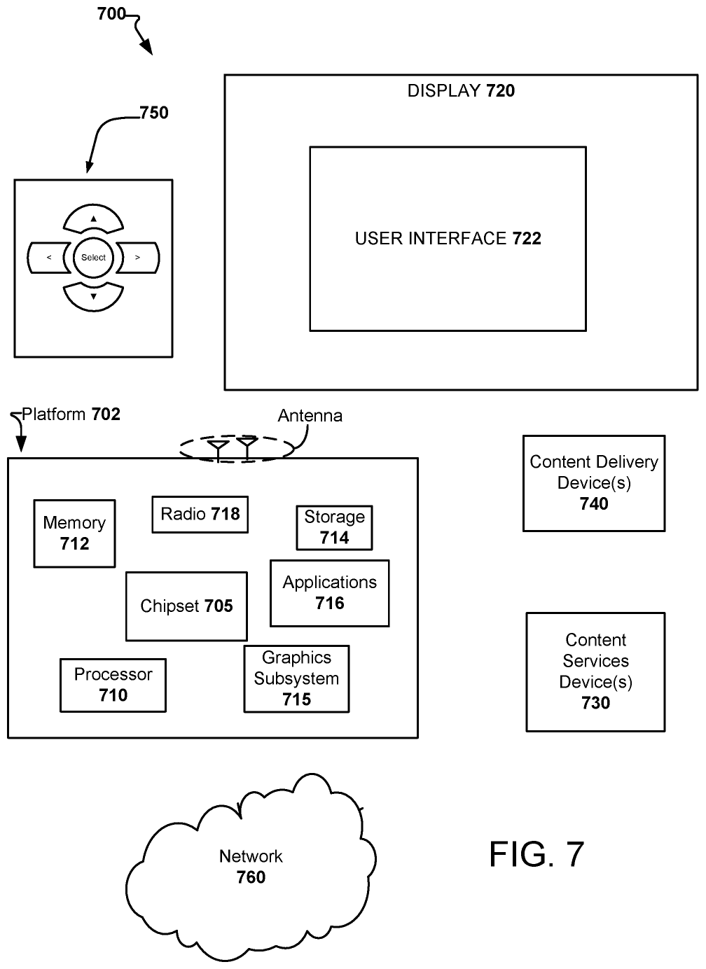

FIG. 1 illustrates a computing device 100 configured to tune a CNN for increased classification accuracy and computational efficiency. As shown in FIG. 1, the computing device 100 includes a processor 102, memory 104, and a CNN Tuner 106. The processor 102 includes various computing circuitry, such as a control unit, an arithmetic-logic unit, and register memory, that can execute instructions defined by an instruction set. In executing the instructions, the processor 102 may operate on data stored in the register memory thereby generating manipulated data. The processor 102 may include a single core processor, a multi-core processor, a micro-controller, or some other data processing device. Features and some examples of the processor 102 are described further below with reference to FIG. 7.

As shown in FIG. 1, the processor 102 is coupled to the memory 104. The memory 104 may incorporate volatile and/or non-volatile data storage (e.g., read-only memory, random access memory, flash memory, magnetic/optical disk, and/or some other computer readable and writable medium). The memory 104 is sized and configured to store programs executable by the processor 102 and, in some examples, copies of at least some of the data used by the programs during execution. Features and some examples of the memory 104 are described further below with reference to FIG. 7.

As shown in FIG. 1, the memory 104 includes a CNN 108. In some examples, the CNN 108 is built, trained, and utilized by the processor 102 to detect and classify content. The CNN 108 may be a “deep” CNN including a sequence of individual layers, with each successive layer operating on data generated by a previous layer. In some examples, the CNN 108 is a deep CNN configured to recognize digits, such as an LeNet-5 CNN. In these examples, the final layer of the artificial neural network is a classification layer that processes data from a preceding layer and maps the data to the specific classes corresponding to digits. In other examples, the CNN 108 has an architecture and purpose different from the LeNet-5 CNN. Thus, the examples disclosed herein are not limited to a particular CNN architecture.

For instance, FIG. 2 illustrates another example of the CNN 108 in greater detail. As shown in FIG. 2, the CNN 108 includes layers 202, 204, 206, and 208. The layer 202 includes neurons 202a-202d. The layer 204 includes neurons 204a-204f and one or more links between one or more of the neurons 202a-202d and one or more of the neurons 204a-204f. The layer 206 includes 206a-206d and one or more links between one or more of the neurons 204a-204f and one or more of the neurons 206a-206d. The layer 208 includes neurons 208a-208d and one or more links between one or more of the neurons 206a-206d and one or more of the neurons 208a-208d. Each of the links depicted in FIG. 2 has an associated weight that affects the contribution of a value stored in a neuron in a previous layer to a value calculated for a neuron in a subsequent layer.

As illustrated in FIG. 2, the layer 202 is an input layer in which each of the neurons 202a-202d stores an input value representative of a portion of the content to be processed by the CNN. The layer 204 is a convolutional layer in which each of the neurons 204a-204f is linked to and receives input values from two of the input neurons 202a-202d. Within the layer 204, each of the neurons 204a-204f is configured to convolve the two input values it receives with a filter to generate and store a convolved value. The layer 206 is a pooling layer in which each of the neurons 206a-206d is linked to and sub samples two of the convolutional neurons 204a-204f to generate and store a pooled value. The layer 208 is a fully connected layer in which each of the neurons 208a-208d is linked to and receives a pooled value from one of the pooling neurons 206a-206d. In some examples, the weight of each link illustrated in FIG. 2 is determine by the processor 102 during execution of a training process, such as a backpropagation process.

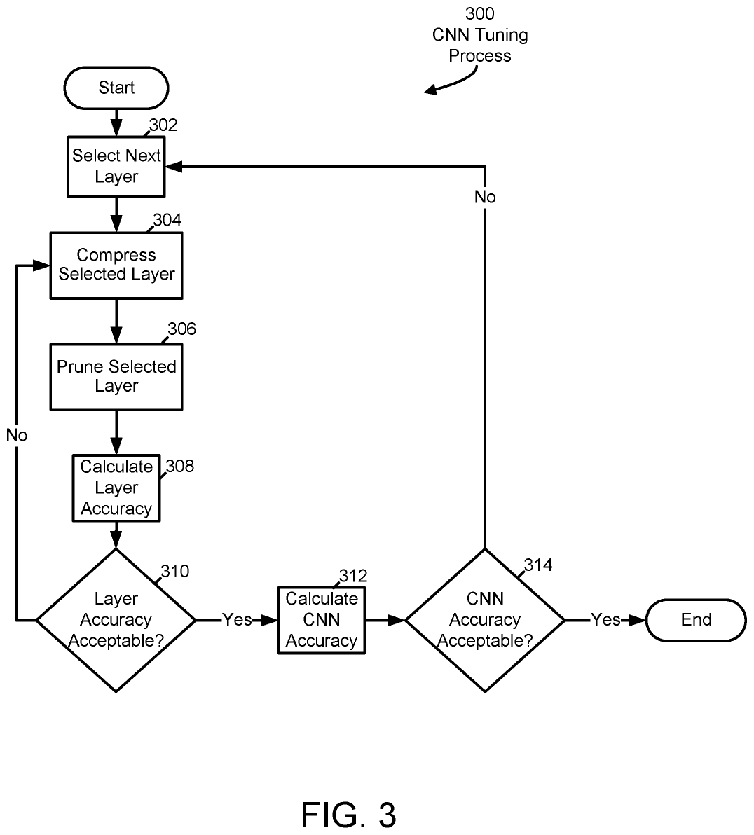

Returning to FIG. 1, the CNN tuner 106 is a hardware and/or software component configured to tune a CNN, such as the CNN 108. When executing according to this configuration in some examples, the CNN tuner 106 compresses layers of the CNN and prunes each compressed layer to generate a tuned layer that is free of neurons and links of low importance to the accuracy of the layer. In some examples, after pruning a layer, the CNN tuner 106 tests the accuracy of the layer and the accuracy of the CNN to determine whether the layer and the CNN meet predefined accuracy criteria. One example of a tuning process executed by some examples of the CNN tuner 106 is described in detail below with reference to FIG. 3.

### Methodology

Some examples disclosed herein execute a tuning process, such as the tuning process 300 illustrated in FIG. 3. The tuning process 300 may be executed by a computing device, such as the computing device 100 described above with reference to FIG. 1. The acts executed by the tuning process 300 collectively tune a CNN (e.g., the CNN 108) to increase its accuracy and computational efficiency.

As illustrated in FIG. 3, the tuning process 300 starts in act 302 with a CNN tuner (e.g., the CNN tuner 106) selecting a next layer of the CNN for tuning. In some examples, this next layer may be the first intermediate layer (e.g., the convolutional layer 204, where the processor is executing the first iteration of the act 302 within an instance of the tuning process 300). The next layer may also be may be an intermediate layer subsequent to the first intermediate layer (e.g., where the processor is executing an iteration of the act 302 subsequent to the first iteration).

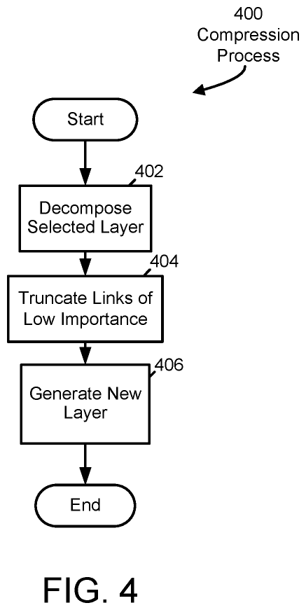

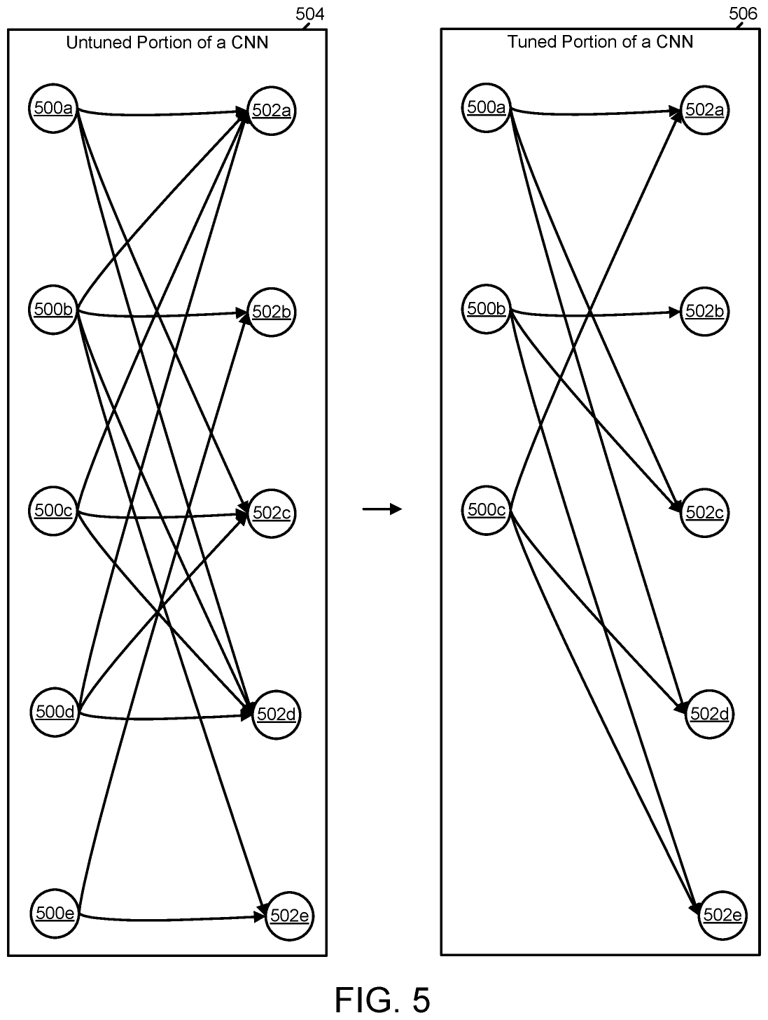

In act 304, the CNN tuner compresses the selected layer. FIG. 4 illustrates a compression process 400 executed in some examples of the act 304. As shown in FIG. 4, the compression process 400 starts in the act 402 with the CNN tuner decomposing the selected layer to expose links within the layer that are of low importance to the layer's accuracy. For instance, in some examples, the CNN tuner uses singular value decomposition (SVD), although other decomposition processes (e.g., polar decomposition, eigendecomposition, etc.) may be used. In examples that use SVD, the CNN tuner executes SVD on a matrix of weight values associated with links in the selected layer, which produces 3 matrices uΣv*. In these examples, the diagonal of the Σ matrix lists singular values that indicate the relative importance of eigenvectors stored in the u and v* matrices to the SVD representation of the weight matrix.

In act 404, the CNN tuner truncates links of low importance to the accuracy of the selected layer. For instance, continuing with the example implementing SVD, the CNN tuner truncates the Σ and v* matrices (and optionally the u matrix) using a predefined and configurable truncation ratio. In some examples, the truncation ratio is expressed as a percentage of the number of singular values (e.g., 10%, 20%, or more) stored in the diagonal. In these examples, the CNN tuner truncates the Σ matrix by calculating a target number of singular values to truncate (e.g., a total number of singular values times the truncation ratio) and zeroing (or removing) a number of the lowest value diagonals equal to the target number. In some examples, the CNN tuner also zeros (or removes) the rows and columns containing the zeroed (or removed) diagonals.

In other examples, the CNN tuner truncates the Σ matrix using a predefined and configurable truncation threshold. In these examples, the CNN tuner truncates the Σ matrix by zeroing (or removing) diagonals having a value less than or equal to the truncation threshold. In some examples, the CNN tuner also zeros (or removes) the rows and columns containing the zeroed (or removed) diagonals. In these and other examples, the CNN tuner truncates the v* matrix by zeroing (or removing) a number of bottom rows equal to the number of zeroed (or removed) diagonals. Similarly, in these examples, the CNN tuner truncates the u matrix by zeroing (or removing) a number of right hand columns equal to the number of zeroed (or removed) diagonals. Still and other examples may truncate matrices using other processes, and the examples disclosed herein are not limited to a particular truncation process.

In act 406, the CNN tuner generates a new layer. For instance, continuing with the example implementing SVD, in the act 406 the CNN tuner generates a new weight matrix by multiplying the truncated matrix by the truncated v* matrix and replacing the weight matrix of the selected layer with the new weight matrix. After the CNN tuner executes the act 406, the compression process 400 ends.

Returning to FIG. 3, in act 306, the CNN tuner prunes links and neurons of low importance from the selected layer (as replaced by the new layer in the act 406 above, in some examples). For instance, in some examples, the CNN tuner prunes the weight matrix of the selected layer using a predefined and configurable pruning ratio. In some examples, the pruning ratio is expressed as a percentage of the number of weight values (e.g., 10%, 20%, or more) stored in a row. In these examples, the CNN tuner prunes the weight matrix by calculating a target number of row values to prune (e.g., total number of row values*the pruning ratio) and zeroing a number of the lowest row values equal to the target number. In other examples, the CNN tuner prunes the weight matrix using a predefined and configurable pruning threshold. In these examples, the CNN tuner prunes the weight matrix by zeroing values less than or equal to the pruning threshold. Still other examples may prune matrices using other processes, and the examples disclosed herein are not limited to a particular pruning process.

In some examples, the zeroing of weight values may render some neurons superfluous (e.g., where a neuron is associated with no links having non-zero weights). In these examples, the CNN tuner also prunes these superfluous neurons within the act 306. Also, in the act 306, the CNN tuner replaces the weight matrix of the selected layer with the pruned weight matrix, thereby creating a newly tuned layer.

In act 308, the CNN tuner calculates the accuracy of the tuned layer of the CNN. In some examples, the CNN tuner calculates the accuracy of the tuned layer using mAP. In act 310, the CNN tuner determines whether the accuracy of the tuned layer meets a predetermined threshold (e.g., the mAP value of the layer is greater than a threshold value). If so, the CNN tuner executes act 312. Otherwise, the CNN tuner returns to the act 304.

In act 312, the CNN tuner calculates the accuracy of the CNN including the newly tuned layer. In some examples, the CNN tuner calculates the accuracy of the CNN using mAP. In act 314, the CNN tuner determines whether the accuracy of the CNN meets a predetermined threshold (e.g., the mAP value of the CNN is greater than a threshold value). If so, the CNN is adequately tuned and the CNN tuning process 300 ends. Otherwise, the CNN tuner returns to the act 302 to select a subsequently layer of the CNN for processing.

Process 300 depicts one particular sequence of acts in a particular example. The acts included in this process may be performed by, or using, one or more computing devices specially configured as discussed herein. Some acts are optional and, as such, may be omitted in accord with one or more examples. Additionally, the order of acts can be altered, or other acts can be added, without departing from the scope of the systems and methods disclosed herein. For instance, in some examples the CNN tuner creates working copies of selected layers and matrices and uses these working copies to execute the acts disclosed in the process 300. Conversely, in some examples, the CNN tuner executes the acts disclosed in the process 300 on selected layers and matrices in place.

### CNN Tuning Example

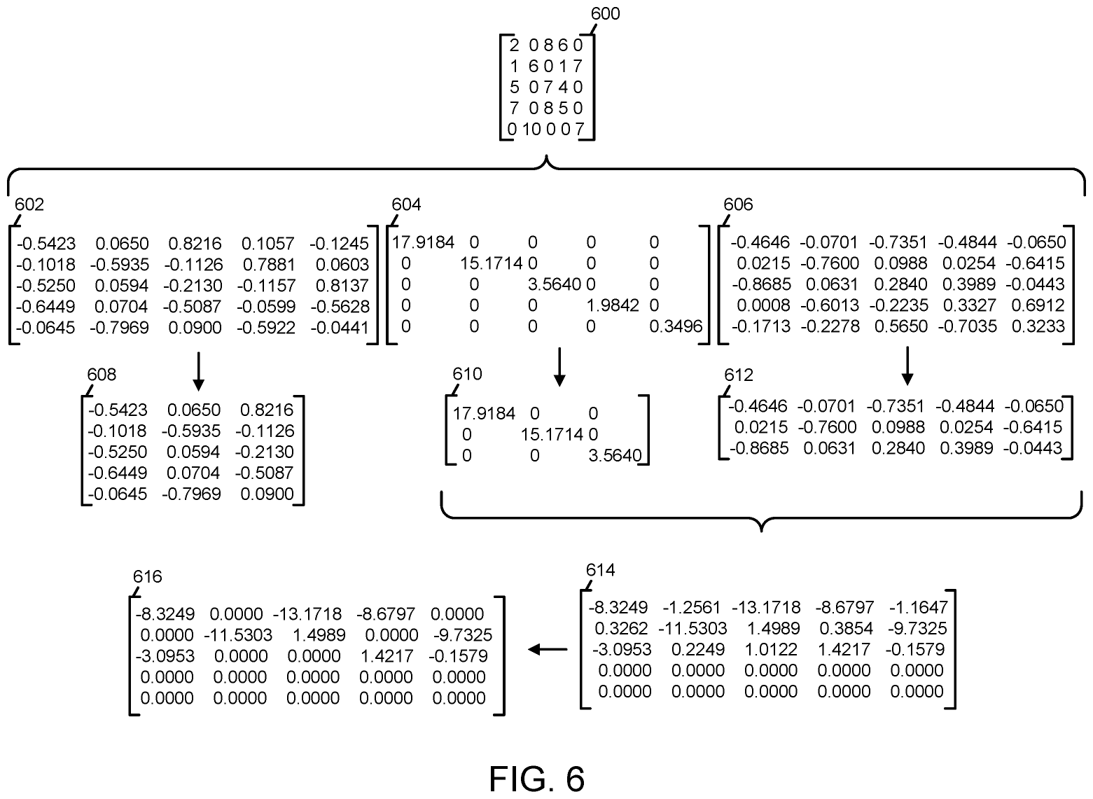

FIGS. 5 and 6 further illustrate the operation of a CNN tuner (e.g., the CNN tuner 106) and a CNN tuning process (e.g., the CNN tuning process 300) executed by the CNN tuner against an untuned portion of a CNN 504. As shown in FIG. 5, the untuned portion of the CNN 504 includes neurons 500a-500e, neurons 502a-502e, and a plurality of links between various pairs of the depicted neurons. The weights associated with these links are listed in a matrix 600 shown in FIG. 6. Rows of the matrix 600 are associated with neurons 400a-400e and columns of the matrix 600 are associated with neurons 502a-502e. Thus, the weight associated with a link between neuron 500a and neuron 502a is stored in the matrix 600 at position 1, 1 and has a value of 2. The weight associated with a link between neuron 500e and neuron 502b is stored in the matrix 600 at position 5, 2 and has a value of 10. A weight having a value of 0 indicates that no link exists between the associated neurons. Thus, according to the matrix 600, no link exists between neuron 500a and 502b because position 1, 2 has a value of 0.

In this tuning example, the CNN tuner executes the act 302 and selects a layer of the portion of the CNN 504 that includes the neurons 502a-502e and the plurality of links between them and the neurons 500a-500e. The CNN tuner next executes the act 304 and compresses the selected layer. In examples of the act 304 directed to SVD, the CNN tuner executes the act 402 and decomposes the matrix 600 into decomposed matrices 602, 604, and 606. In these SVD examples, the CNN tuner next executes the act 404 and truncates the decomposed matrices 604 and 606 to generate the compressed matrices 610 and 612. Optionally, within the act 404, the CNN tuner truncates the decomposed matrix 602 to generate the compressed matrix 608. Continuing the SVD examples, the CNN tuner next executes the act 406 to generate a new matrix 614 (and layer) by multiplying the compressed matrix 610 by the compressed matrix 612.

The CNN tuner next executes the act 306 and prunes the new matrix 614 to generate the pruned matrix 616 and replaces the matrix 600 in the CNN with the pruned matrix 616, thereby completing tuning of the selected layer. The CNN tuner next executes the act 308 and calculates the accuracy of the tuned layer. The CNN tuner next executes the act 310 and determines that the accuracy of the tuned layer is acceptable by comparing the calculated accuracy value for the tuned layer to a predetermined threshold value for the layer and determining that the calculate accuracy exceeds the predetermined threshold value. The CNN tuner next executes the act 312 and calculates the accuracy of the entire CNN including the newly tuned layer. The CNN tuner next executes that act 314 and determines that the accuracy of the entire CNN is acceptable by comparing the calculated accuracy value for the entire CNN to a predetermined threshold value for the entire CNN and determining that the calculate accuracy exceeds the predetermined threshold value. Having successfully tuned the CNN, the CNN tuner next terminates the CNN tuning process.

The tuned portion of the CNN 506 illustrates the untuned portion of the CNN 504 after the CNN tuner replaces the matrix 600 with the matrix 612. As shown, the tuned portion of the CNN does not have neurons 500d or 500e as the links associated with these neurons were pruned by the CNN tuner's execution of the tuning process. Also as shown, the CNN tuner has pruned links between the following pairs of neurons: 500a and 502b, 500a and 502e, 500b and 502a, 500b and 502d, 500c and 502b, and 500c and 502c. The resulting, tuned portion of the CNN 506 is less computationally intensive than the untuned portion of the CNN 504 due to the decreased number of neurons and links present in the tuned portion of the CNN 506.

### Example Computing Devices

FIG. 7 illustrates another example of a computing device, a computer system 700, configured in accordance with an example of the present disclosure. The system 700 may be incorporated into a personal computer (PC), laptop computer, ultra-laptop computer, all-in-one, cockpit defined computer system for automobiles, converged mobility device, wearable device, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, set-top box, game console, or other such computing environments capable of performing graphics rendering operations and displaying content.

In some examples, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720, so as to supplement navigational gesturing by the user. Each of these example components is described in more detail below.

In some examples, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented, for example, as Complex Instruction Set Computer (CISC) or Reduced Instruction Set Computer (RISC) processors, x86 instruction set compatible processors, multi-core, or any other microprocessor or central processing unit (CPU). In some examples, processor 710 may comprise dual-core processor(s), dual-core mobile processor(s), and so forth. Memory 712 may be implemented, for instance, as a volatile memory device such as, but not limited to, a Random Access Memory (RAM), Dynamic Random Access Memory (DRAM), or Static RAM (SRAM). Storage 714 may be implemented, for example, as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some examples, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705. The graphics and/or video processing techniques may be implemented in various hardware architectures. For example, graphics and/or video functionality may be integrated within a chipset. Alternatively, a discrete graphics and/or video processor may be used. As still another example, the graphics and/or video functions may be implemented by a general purpose processor, including a multi-core processor. In a further example, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In some examples, display 720 may comprise any television or computer type monitor or display. Under the control of one or more software applications 716, platform 702 may display a user interface 722 on display 720.

In some examples, content services device(s) 730 may be hosted by any national, international and/or independent service and thus accessible to platform 702 via the Internet or other network, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720. In some examples, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, graphics, text, medical and gaming content, and so forth.

Content services device(s) 730 receives content such as cable television programming including media information, digital information, and/or other content. Examples of content providers may include any cable or satellite television or radio or Internet content providers. The provided examples are not meant to limit the present disclosure. In some examples, platform 702 may receive control signals from navigation controller 750 having one or more navigation features. The navigation features of controller 750 may be used to interact with user interface 722, for example. In some examples, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures, facial expressions, or sounds.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In some examples, controller 750 may not be a separate component but integrated into platform 702 and/or display 720. Examples, however, are not limited to the elements or in the context shown or described herein, as will be appreciated.

In some examples, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off” In addition, chipset 705 may comprise hardware and/or software support for 5.1 surround sound audio and/or high definition 7.1 surround sound audio, for example. Drivers may include a graphics driver for integrated graphics platforms. In some examples, the graphics driver may comprise a peripheral component interconnect (PCI) express graphics card.

In various examples, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various examples, platform 702 and display 720 may be an integrated unit. Display 720 and content service device(s) 730 may be integrated, or display 720 and content delivery device(s) 740 may be integrated, for example. These examples are not meant to limit the present disclosure.

In various examples, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, email or text messages, voice mail message, alphanumeric symbols, graphics, image, video, text and so forth. Control information may refer to any data representing commands, instructions or control words meant for an automated system. For example, control information may be used to route media information through a system, or instruct a node to process the media information in a predetermined manner. The examples, however, are not limited to the elements or context shown or described in FIG. 7.

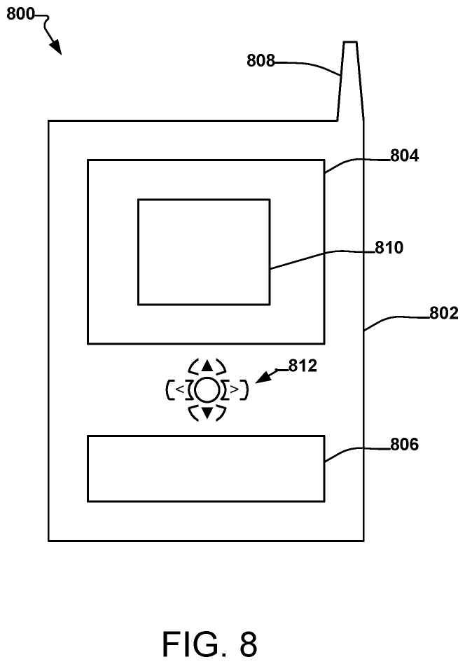

As described above, system 700 may be embodied in varying physical styles or form factors. FIG. 8 illustrates examples of a small form factor device 800 in which system 700 may be embodied. In some examples, for example, device 800 may be implemented as a mobile computing device having wireless capabilities. A mobile computing device may refer to any device having a processing system and a mobile power source or supply, such as one or more batteries, for example.

As previously described, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In some examples, for example, a mobile computing device may be implemented as a smart phone capable of executing computer applications, as well as voice communications and/or data communications. Although some examples may be described with a mobile computing device implemented as a smart phone by way of example, it may be appreciated that other examples may be implemented using other wireless mobile computing devices as well. The examples are not limited in this context.

As shown in FIG. 8, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device, such as user interface 810. I/O device 806 may comprise any suitable I/O device for entering information into a mobile computing device. Examples for I/O device 806 may include an alphanumeric keyboard, a numeric keypad, a touch pad, input keys, buttons, a camera, switches, rocker switches, microphones, speakers, voice recognition device and software, and so forth. Information also may be entered into device 800 by way of microphone. Such information may be digitized by a voice recognition device. The examples are not limited in this context.

Various examples may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Whether hardware elements and/or software elements are used may vary from one example to the next in accordance with any number of factors, such as desired computational rate, power levels, heat tolerances, processing cycle budget, input data rates, output data rates, memory resources, data bus speeds and other design or performance constraints.

Some examples may be implemented, for example, using a non-transitory machine-readable medium or article or computer program product which may store an instruction or a set of instructions that, if executed by a machine, may cause the machine to perform a method and/or operations in accordance with an example of the present disclosure. Such a machine may include, for example, any suitable processing platform, computing platform, computing device, processing device, computing system, processing system, computer, processor, or the like, and may be implemented using any suitable combination of hardware and software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of executable code implemented using any suitable high-level, low-level, object-oriented, visual, compiled and/or interpreted programming language.

### Further Examples

The following examples pertain to further examples, from which numerous permutations and configurations will be apparent.

Example 1 is a computing device comprising a memory storing a convolutional neural network (CNN) comprising a plurality of layers and at least one processor coupled to the memory. The processor is configured to select a layer of the plurality of layers; compress the layer to generate a compressed layer; prune the compressed layer to generate a tuned layer to replace the layer of the plurality of layers.

Example 2 includes the subject matter of Example 1, wherein the CNN is trained to classify content and the at least one processor is further configured to receive the content; and classify, after generating the tuned layer, the content using the CNN.

Example 3 includes the subject matter of either Example 1 or Examples 2, wherein the layer is a convolutional layer, a pooling layer, or a fully-connected layer.

Example 4 includes the subject matter of any of Examples 1-3, wherein the layer comprises at least one matrix and the at least one processor is configured to compress the layer at least in part by decomposing the at least one matrix to generate at least one decomposed matrix; and truncating the at least one decomposed matrix to generate at least one compressed matrix.

Example 5 includes the subject matter of Example 4, wherein the at least one processor is configured to execute singular value decomposition in decomposing the at least one matrix; the at least one decomposed matrix comprises at least one u matrix, at least one Σ matrix, and at least one v* matrix; truncating the at least one decomposed matrix comprises truncating the at least one Σ matrix; and the at least one processor is further configured to multiply the at least one compressed matrix by the at least one v* matrix to generate at least one new matrix.

Example 6 includes the subject matter of Example 5, wherein the at least one processor is configured to prune the compressed layer at least in part by identifying at least one weight value stored in the at least one new matrix that is less than a threshold value, replacing the at least one weight value with 0, and removing at least one neuron associated with at least one link associated with the at least one weight value.

Example 7 includes the subject matter of any of Examples 1-6, wherein the at least one processor is further configured to calculate an accuracy of the tuned layer and compress and prune the tuned layer in response to the accuracy being less than a threshold value.

Example 8 includes the subject matter of any of Examples 1-7, wherein the at least one processor is further configured to calculate an accuracy of the CNN and compress and prune another layer of the plurality of layers in response to the accuracy being less than a threshold value.

Example 9 is a method of tuning a convolutional neural network (CNN) comprising a plurality of layers. The method comprises selecting a layer of the plurality of layers; compressing the layer to generate a compressed layer; pruning the compressed layer to generate a tuned layer to replace the layer of the plurality of layers.

Example 10 includes the subject matter of Example 9, wherein the CNN is trained to classify content and the method further comprises receiving the content; and classifying, after generating the tuned layer, the content using the CNN.

Example 11 includes the subject matter of either Example 9 or Example 10, wherein selecting the layer comprises selecting a convolutional layer, a pooling layer, or a fully-connected layer.

Example 12 includes the subject matter of any of Examples 9-11, wherein the layer comprises at least one matrix and compressing the layer comprises decomposing the at least one matrix to generate at least one decomposed matrix; and truncating the at least one decomposed matrix to generate at least one compressed matrix.

Example 13 includes the subject matter of Example 12, wherein decomposing the at least one matrix comprises executing singular value decomposition; the at least one decomposed matrix comprises at least one u matrix, at least one Σ matrix, and at least one v* matrix; truncating the at least one decomposed matrix comprises truncating the at least one Σ matrix; and the method further comprises multiplying the at least one compressed matrix by the at least one v* matrix to generate at least one new matrix.

Example 14 includes the subject matter of Examples 13, wherein pruning the compressed layer comprises identifying at least one weight value stored in the at least one new matrix that is less than a threshold value; replacing the at least one weight value with 0; and removing at least one neuron associated with at least one link associated with the at least one weight value.

Example 15 includes the subject matter of any of Examples 9-14, further comprising calculating an accuracy of the tuned layer and compressing and pruning the tuned layer in response to the accuracy being less than a threshold value.

Example 16 includes the subject matter of any of Examples 9-15, further comprising calculating an accuracy of the CNN and compressing and pruning another layer of the plurality of layers in response to the accuracy being less than a threshold value.

Example 17 is a non-transient computer readable medium encoded with instructions that when executed by at least one processor cause a process for tuning a convolutional neural network (CNN) comprising a plurality of layers to be carried out. The process comprises selecting a layer of the plurality of layers; compressing the layer to generate a compressed layer; pruning the compressed layer to generate a tuned layer to replace the layer of the plurality of layers.

Example 18 includes the subject matter of Example 17, wherein the CNN is trained to classify content and the process further comprises receiving the content and classifying, after generating the tuned layer, the content using the CNN.

Example 19 includes the subject matter of either Example 17 or Example 18, wherein selecting the layer comprises selecting a convolutional layer, a pooling layer, or a fully-connected layer.

Example 20 includes the subject matter of any of Examples 17-19, wherein the layer comprises at least one matrix and compressing the layer comprises decomposing the at least one matrix to generate at least one decomposed matrix and truncating the at least one decomposed matrix to generate at least one compressed matrix.

Example 21 includes the subject matter of Example 20, wherein decomposing the at least one matrix comprises executing singular value decomposition; the at least one decomposed matrix comprises at least one u matrix, at least one Σ matrix, and at least one V* matrix; truncating the at least one decomposed matrix comprises truncating the at least one Σ matrix; and the process further comprises multiplying the at least one compressed matrix by the at least one v* matrix to generate at least one new matrix.

Example 22 includes the subject matter of Example 21, wherein pruning the compressed layer comprises identifying at least one weight value stored in the at least one new matrix that is less than a threshold value; replacing the at least one weight value with 0; and removing at least one neuron associated with at least one link associated with the at least one weight value.

Example 23 includes the subject matter of any of Examples 17-22, the process further comprising calculating an accuracy of the tuned layer and compressing and pruning the tuned layer in response to the accuracy being less than a threshold value.

Example 24 includes the subject matter of any of Examples 17-23, the process further comprising calculating an accuracy of the CNN and compressing and pruning another layer of the plurality of layers in response to the accuracy being less than a threshold value.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

1. A non-transitory computer-readable medium comprising instructions stored thereon, that if executed by one or more processors, cause the one or more processors to:
access a neural network (NN) comprising a plurality of layers, wherein at least one layer of the plurality of layers comprises at least one weight;
select a layer of the plurality of layers; and
adjust weights of the selected layer based on a pruning ratio.

2. The computer-readable medium of claim 1, wherein the pruning ratio controls a number of weights to be adjusted.

3. The computer-readable medium of claim 1, wherein the adjust weights of the selected layer based on a pruning ratio comprises change values of at least one of the weights to zero.

4. The computer-readable medium of claim 1, comprising instructions stored thereon, that if executed by one or more processors, cause the one or more processors to:
determine the pruning ratio based on a target number of row values to prune.

5. The computer-readable medium of claim 1, wherein the select a layer of the plurality of layers comprises select a convolutional layer, a pooling layer, or a fully-connected layer.

6. The computer-readable medium of claim 1, comprising instructions stored thereon, that if executed by one or more processors, cause the one or more processors to:
classify one or more objects based on the plurality of layers of the neural network.

7. A method comprising:
accessing a neural network (NN) comprising a plurality of layers, wherein at least one layer of the plurality of layers comprises at least one weight;
selecting a layer of the plurality of layers; and
adjusting weights of the selected layer based on a pruning ratio.

8. The method of claim 7, wherein the pruning ratio controls a number of weights to be adjusted.

9. The method of claim 7, wherein the adjusting weights of the selected layer based on a pruning ratio comprises change values of at least one of the weights to zero.

10. The method of claim 7, comprising:
determining the pruning ratio based on a target number of row values to prune.

11. The method of claim 7, wherein the selecting a layer of the plurality of layers comprises select a convolutional layer, a pooling layer, or a fully-connected layer.

12. The method of claim 7, comprising:
classifying one or more objects based on the plurality of layers of the neural network.

13. An apparatus comprising:
at least one processor; and
a machine-readable storage storing instructions, the instructions executable by the at least one processor to:
access a neural network (NN) comprising a plurality of layers, wherein at least one layer of the plurality of layers comprises at least one weight;
select a layer of the plurality of layers; and
adjust weights of the selected layer based on a pruning ratio.

14. The apparatus of claim 13, wherein the pruning ratio controls a number of weights to be adjusted.

15. The apparatus of claim 13, wherein the adjust weights of the selected layer based on a pruning ratio comprises change values of at least one of the weights to zero.

16. The apparatus of claim 13, comprising instructions executable by the at least one processor to:
determine the pruning ratio based on a target number of row values to prune.

17. The apparatus of claim 13, wherein the select a layer of the plurality of layers comprises select a convolutional layer, a pooling layer, or a fully-connected layer.

18. The apparatus of claim 13, comprising instructions executable by the at least one processor to:
classify one or more objects based on the plurality of layers of the neural network.

19. The apparatus of claim 13, comprising:
a memory device coupled to the at least one processor, wherein the memory device is to store the machine-readable storage storing instructions.

20. The apparatus of claim 13, comprising:
an antenna coupled to the at least one processor and a wireless radio device coupled to the at least one processor.

21. The apparatus of claim 13, comprising:
a battery device coupled to the at least one processor.
